(19) United States
(12) Patent Application Publication
(10) Pub. No.: US 2022/0379664 A1
(43) Pub. Date: Dec. 1, 2022

(54) UTILITY VEHICLE TIRE

(71) Applicant: Continental Reifen Deutschland GmbH, Hannover (DE)

(72) Inventors: Helge Rother, Garbsen (DE); Florian Kristen, Burgwedel (DE); Andreas Schwenke, Isernhagen (DE); Chun Yi Yeo, Hannover (DE)

(73) Assignee: Continental Reifen Deutschland GmbH, Hannover (DE)

(21) Appl. No.: 17/755,234

(22) PCT Filed: Oct. 13, 2020
(86) PCT No.: PCT/EP2020/078737

§ 371 Date: Apr. 25, 2022

(30) Foreign Application Priority Data
Nov. 19, 2019 (DE) 10 2019 217 828.6

(51) Int. Cl. B60C 11/01; B60C 13/02; B60C 13/00

(52) U.S. Cl. CPC B60C 11/01; B60C 13/02; B60C 13/002

(57) ABSTRACT

The invention relates to a utility vehicle tire having sidewalls (2) and having a tread (1) with shoulder-side profile ribs (3), which shoulder-side profile ribs have shoulder-side profile blocks (6) which are separated from one another by transverse channels (5) and which have in each case one flank surface (6a) running in the direction of the adjoining sidewall (2), wherein, on at least one sidewall (2), there is formed a flank guard (7′) which adjoins the shoulder-side profile blocks (6) and which is elevated in relation to the level of the sidewall (2). It is the intention for the flank guard to be designed such that the risk of crack formation is greatly reduced. This is achieved in that the flank guard (7′) is formed from a multiplicity of wedge-shaped elevations (7), wherein each wedge-shaped elevation (7) adjoins the flank surface (6a) of a shoulder-side profile block (6) and has an outer surface (7a) which, in the tire cross section, transitions without a kink into the flank surface (6a) of the profile block (6).

The invention relates to a utility vehicle tire having sidewalls and having a tread with shoulder-side profile ribs, which shoulder-side profile ribs have shoulder-side profile blocks which are separated from one another by transverse channels and which have in each case one flank surface running in the direction of the adjoining sidewall, wherein, on at least one sidewall, there is formed a flank guard which adjoins the shoulder-side profile blocks and which is elevated in relation to the level of the sidewall.

A flank guard formed on the sidewalls of utility vehicle tires protects the sidewall regions and the “off-shoulder regions” of the tread from damage such as cracks, cuts or increased wear, which can occur for example in the event of contact with curbs or during driving on unpaved roads.

A utility vehicle tire of the type mentioned in the introduction is currently (as of October 2019) known and available under the designation Conti HDC 3. On each sidewall, this tire has a flank rib which runs in encircling fashion around the circumference of the sidewall and which has an edge which runs in encircling fashion in a circumferential direction. The flank rib of relatively massive form offers, above all, good protection against damage.

The invention is based on the object, in the case of a utility vehicle tire of the type mentioned in the introduction, of designing a flank guard such that, with good protection against damage, crack formation can also be reliably prevented.

The stated object is achieved according to the invention in that the flank guard is formed from a multiplicity of wedge-shaped elevations, wherein each wedge-shaped elevation adjoins the flank surface of a shoulder-side profile block and has an outer surface which, in the tire cross section, transitions without a kink into the flank surface of the profile block.

The flank guard provided according to the invention is therefore composed of individual wedge-shaped elevations which, in comparison to the hitherto conventional encircling flank ribs, require less rubber material, are significantly more stable, and have little or no tendency to crack owing to the kink-free transition of their outer surfaces into the shoulder-side flank surfaces of the profile blocks.

An embodiment is particularly advantageous in which each wedge-shaped elevation adjoins the flank surface over its length measured in a circumferential direction.

In a preferred embodiment, as viewed in the tire cross section, each wedge-shaped elevation has a maximum width of 3.0 mm to 7.0 mm, in particular of 4.0 mm to 5.0 mm, measured at the level of the sidewall and in a radial direction. Such a flank guard requires only little rubber material.

In this context, it is furthermore expedient if each wedge-shaped elevation has a thickness measured perpendicular to the level of the sidewall, which thickness, as viewed in the tire cross section, increases over the extent of the outer surface in the direction of the sidewall proceeding from the flank surface of the shoulder-side profile block.

It is furthermore preferable here if each wedge-shaped elevation has a maximum thickness of 1.0 mm to 3.0 mm, in particular of 1.5 mm to 2.5 mm.

The risk of crack formation is additionally reduced if, as viewed in the tire cross section, the outer surface of each wedge-shaped elevation is continuously inwardly curved, in particular in the shape of a circular arc.

A further preferred embodiment that requires little rubber material is characterized in that each wedge-shaped elevation has an isosceles trapezoidal shape as seen in a view directed toward the sidewall, wherein the longer base side of the trapezoid is situated at the connection of the outer surface of the elevation to the flank surface of the shoulder-side profile block.

In this embodiment, it has proven to be particularly advantageous if each wedge-shaped elevation has, at the shorter base side of the trapezoid, a length measured in the circumferential direction which is 40% to 70%, in particular 50% to 60%, of the length of the flank surface of the shoulder-side profile block measured in the circumferential direction.

A flank guard composed of a multiplicity of wedge-shaped elevations is preferably formed on each sidewall.

For the stability of the elevations, it is advantageous if these have delimiting surfaces which run between their outer surface and the respective sidewall and which enclose an angle of 90° to 130°, in particular of at least 100°, with the sidewall.

Further features, advantages and details of the invention will now be described in more detail with reference to the drawing, which schematically shows an exemplary embodiment of the invention. In the drawing:

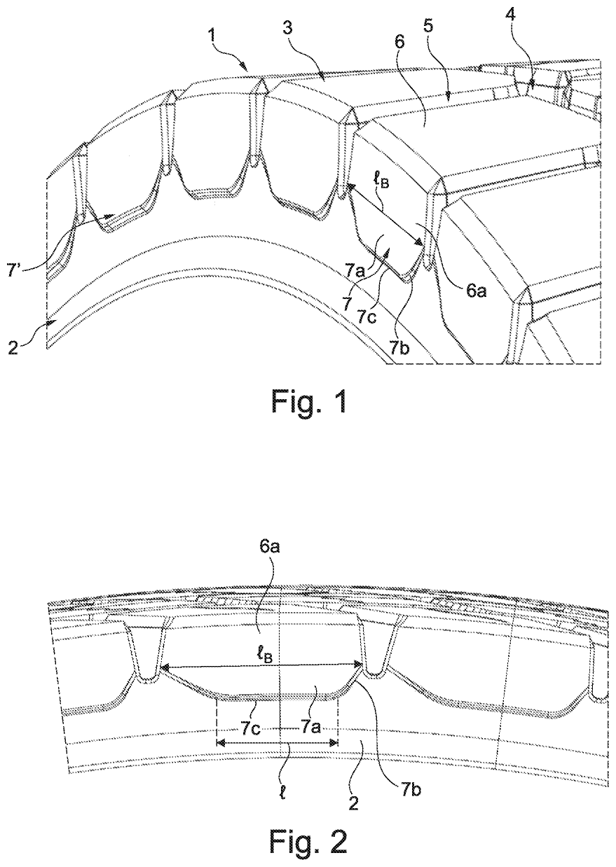

FIG. 1 shows a view of a portion of a shoulder region of a utility vehicle tire with a design variant of the invention,

FIG. 2 shows a further view of a part of the portion from FIG. 1,

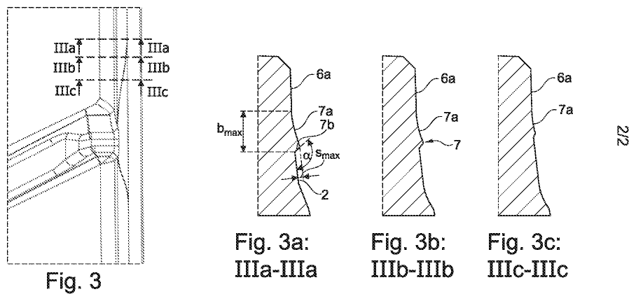

FIG. 3 shows an enlarged plan view of a transverse channel running in the shoulder region,

FIG. 3a shows a section along the line IIIa-IIIa in FIG. 3,

FIG. 3b shows a section along the line IIIb-IIIb in FIG. 3, and

FIG. 3c shows a section along the line IIIc-IIIc in FIG. 3.

Utility vehicle tires designed according to the invention are in particular truck tires of radial construction.

FIG. 1 shows a shoulder-side partial region of a tread 1 and a circumferential portion of a sidewall 2 of a utility vehicle tire. At each tire shoulder, the tread 1 has a shoulder-side profile rib 3 which runs in encircling fashion in a circumferential direction and which is delimited to the inside of the tread by a circumferential channel 4. Situated between the shoulder-side profile ribs 3 is a profiled, middle tread region which, in a preferred embodiment, has further profile ribs.

Each shoulder-side profile rib 3 is subdivided into substantially cuboid profile blocks 6 by transverse channels 5 of known design, which emerge at the outside of the tread. Outside the ground contact patch, each profile block 6 has a shoulder-side flank surface 6a which runs, between mutually adjacent transverse channels, in a direction toward the sidewall 2. The flank surface 6a has—measured at its margin facing toward the sidewall 2—a length l_{B} in a circumferential direction, which length correlates with the spacing between the transverse channels 5.

Situated on the sidewall 2 is a flank guard 7′ which runs in encircling fashion in a circumferential direction and which is formed from a multiplicity of successive wedge-shaped elevations 7, which are triangular in the tire cross section (FIG. 3a). The wedge-shaped elevations 7 are each assigned to one of the shoulder-side profile blocks 6, wherein each wedge-shaped elevation 7 adjoins the shoulder-side flank surface 6a of the respective profile block 6 over the entire length l_{B}.

Each wedge-shaped elevation 7 has an outer surface 7a which, in the tire cross section, is continuously slightly inwardly curved, in particular in the shape of a circular arc, and which is uniform with the flank surface 6a of the profile block 6 (FIG. 3a to FIG. 3c). Accordingly, as viewed in the tire cross section, the outer surface 7a transitions into the flank surface 6a without a kink. In FIG. 1, at the numbered wedge-shaped elevation 7, the connection of the outer surface 7a to the corresponding flank surface 6a is indicated by dashed lines.

In the exemplary embodiment shown, the wedge-shaped elevation 7 and its outer surface 7a have an isosceles trapezoidal shape as seen in a view directed toward the sidewall 2, wherein the longer base side of the associated trapezoid (=base of the trapezoid) is situated at the connection of the outer surface 7a to the flank surface 6a (see also FIG. 2).

The wedge-shaped elevation 7 furthermore has two triangular side surfaces 7b, which each adjoin one of the trapezoid legs of the trapezoid of the outer surface 7a of said elevation and run to the sidewall 2, and a substantially rectangular delimiting surface 7c, which adjoins the short base side of the trapezoid of the outer surface 7a of said elevation and runs between the side surfaces 7b (see also FIG. 2). The triangular side surfaces 7b and the rectangular delimiting surface 7c each enclose an angle α (shown in FIG. 3a for the delimiting surface 7c) of 90° to 130°, in particular of at least 100°, with the sidewall 2. The transition of the side surfaces 7b to the delimiting surface 7c and the transition of the outer surface 7a to the side surfaces 7b and to the delimiting surface 7c is preferably rounded. In accordance with the wedge shape of the elevation 7, the side surfaces 7b end at the mutual connection of the outer surface 7a and the flank surface 6a.

Owing to its wedge shape, the elevation 7 has a thickness measured perpendicularly to the level of the sidewall 2, which thickness increases continuously in the direction of the rectangular delimiting surface 7c proceeding from the mutual connection of the outer surface 7a and the flank surface 6a. At the transition region of the outer surface 7a to the rectangular delimiting surface 7c, the elevation 7 has a maximum thickness sₘₐₓ, measured in relation to the locally adjacent level of the sidewall 2 (FIG. 3a), of 1.0 mm to 3.0 mm, in particular of 1.5 mm to 2.5 mm. Furthermore, as viewed in the tire cross section, the elevation 7 has a maximum width bₘₐₓ, which correlates with the height of its trapezoid and is measured at the level of the sidewall 2 (FIG. 3a), of 3.0 mm to 7.0 mm, in particular of 4.0 mm to 5.0 mm, and a length l (FIG. 2), measured in a circumferential direction without taking into account any rounded portions on the delimiting surface 7c, of 40% to 70%, in particular of 50% to 60%, of the abovementioned length l_{B} of the flank surface 6a.

The wedge-shaped elevations 7 are composed at least for the most part, in particular entirely, of the rubber material of the sidewall 2.

The invention is not limited to the exemplary embodiment described.

In particular, the elevations 7 may have a shape that deviates from the isosceles trapezoidal shape. The elevations 7 may in particular have an asymmetrical trapezoidal shape, or the shape of a rectangle, as seen in a view directed toward the sidewall 2. A flank guard formed from elevations 7 is preferably situated on each sidewall.

### LIST OF REFERENCE SIGNS

1 . . . Tread
2 . . . Sidewall
3 . . . Shoulder-side profile rib
4 . . . Shoulder-side circumferential channel
5 . . . Transverse channel
6 . . . Shoulder-side profile block
6a . . . Shoulder-side flank surface
7 . . . Elevation
7a . . . Outer surface
7b . . . Side surface
7c . . . Delimiting surface
7′ . . . Flank guard
bₘₐₓ . . . Maximum width
l, l_{B} . . . Length
sₘₐₓ . . . Maximum thickness
α . . . Angle

1.-10. (canceled)

11. A utility vehicle tire comprising sidewalls (2) and a tread (1) with shoulder-side profile ribs (3), wherein the shoulder-side profile ribs have shoulder-side profile blocks (6) which are separated from one another by transverse channels (5) and which have in each case one flank surface (6a) running in a direction of the adjoining sidewall (2), wherein, on at least one of the sidewalls (2), there is formed a flank guard (7′) which adjoins the shoulder-side profile blocks (6) and which is elevated in relation to a level of the sidewall (2);
wherein the flank guard (7′) is formed from a multiplicity of wedge-shaped elevations (7), and wherein each of the wedge-shaped elevations (7) adjoins the flank surface (6a) of a shoulder-side profile block (6) and has an outer surface (7a) which, in a tire cross section, transitions without a kink into the flank surface (6a) of the profile block (6).

12. The utility vehicle tire as claimed in claim 11, wherein each of the wedge-shaped elevations (7) adjoins the flank surface (6a) over its length (l_{b}) as measured in a circumferential direction.

13. The utility vehicle tire as claimed in claim 11, wherein, as viewed in the tire cross section, each of the wedge-shaped elevations (7) has a maximum width (bₘₐₓ) of from 3.0 mm to 7.0 mm, as measured at the level of the sidewall (2) and in a radial direction.

14. The utility vehicle tire as claimed in claim 13, wherein the maximum width (bₘₐₓ) is from 4.0 mm to 5.0 mm.

15. The utility vehicle tire as claimed in claim 11, wherein each of the wedge-shaped elevations (7) has a thickness measured perpendicular to the level of the sidewall (2), which thickness, as viewed in the tire cross section, increases over the extent of the outer surface (7a) in the direction of the sidewall (2) proceeding from the flank surface (6a) of the shoulder-side profile block (6).

16. The utility vehicle tire as claimed in claim 11, wherein each of the wedge-shaped elevations (7) has a maximum thickness (sₘₐₓ) of from 1.0 mm to 3.0 mm.

17. The utility vehicle tire as claimed in claim 16, wherein the maximum thickness (sₘₐₓ) is from 1.5 mm to 2.5 mm.

18. The utility vehicle tire as claimed in claim 11, wherein, as viewed in the tire cross section, an outer surface (7a) of each of the wedge-shaped elevations (7) is continuously inwardly curved.

19. The utility vehicle tire as claimed in claim 11, wherein, as viewed in the tire cross section, an outer surface (7a) of each of the wedge-shaped elevations (7) is in a shape of a circular arc.

20. The utility vehicle tire as claimed in claim 11, wherein each of the wedge-shaped elevations (7) has an isosceles trapezoidal shape as seen in a view directed toward the sidewall (2).

21. The utility vehicle tire as claimed in claim 20, wherein a longer base side of the trapezoid is situated at a connection of an outer surface (7a) of the elevation (7) to the flank surface (6a) of the shoulder-side profile block (6).

22. The utility vehicle tire as claimed in claim 20, wherein each of the wedge-shaped elevations (7) has, at a shorter base side of the trapezoid, a length (1), measured in a circumferential direction, which is from 40% to 70%, of a length (1B) of the flank surface (6a) of the shoulder-side profile block (6) measured in the circumferential direction.

23. The utility vehicle tire as claimed in claim 22, wherein the length (1), measured in the circumferential direction, is from 50% to 60%, of the length (1B) of the flank surface (6a) of the shoulder-side profile block (6) measured in the circumferential direction.

24. The utility vehicle tire as claimed in claim 11, wherein each of the wedge-shaped elevations (7) has shape which deviates from an isosceles trapezoidal shape as seen in a view directed toward the sidewall (2).

25. The utility vehicle tire as claimed in claim 11, wherein each of the wedge-shaped elevations (7) has a rectangular shape as seen in a view directed toward the sidewall (2).

26. The utility vehicle tire as claimed in claim 11, wherein a flank guard (7′) composed of a plurality of the wedge-shaped elevations (7) is formed on each of the sidewalls (2).

27. The utility vehicle tire as claimed in claim 11, wherein each of the wedge-shaped elevations (7) has delimiting surfaces (7b, 7c) which run between its outer surface (7a) and a respective sidewall (2).

28. The utility vehicle tire as claimed in claim 27, wherein each of the wedge-shaped elevations (7) enclose an angle (α) of 90° to 130°, in particular of at least 100°, with the respective sidewall (2).

29. The utility vehicle tire as claimed in claim 27, wherein each of the wedge-shaped elevations (7) enclose an angle (α) of at least 100°, with the respective sidewall (2).
